(19) United States
(12) Patent Application Publication
(10) Pub. No.: US 2005/0157326 A1
(43) Pub. Date: Jul. 21, 2005

(54) Multi-functional peripheral device (MFP) and method of indicating a shortage of printing media

(76) Inventor: Sung-soo Lee, Anyang-si (KR)

Correspondence Address: STANZIONE & KIM, LLP, 1740 N STREET, N.W., FIRST FLOOR, WASHINGTON, DC, 20036, US

(21) Appl. No.: 11/003,980

(22) Filed: Dec. 6, 2004

(30) Foreign Application Priority Data
Jan. 15, 2004 (KR) 2004-3049

(51) Int. Cl. H04N 1/21; H04N 1/32; H04N 1/00

(52) U.S. Cl. 358/1.14; 358/468; 358/1.16; 358/441; 358/444

(57) ABSTRACT

A multi-functional peripheral device and a method thereof that indicates a shortage of printing media. In a method of indicating a shortage of printing media in a multi-functional peripheral which receives a predetermined data including fax data from an external source and prints the received data, the method includes printing the received fax data on a printing medium; determining through a predetermined fax protocol data which is received from the external source at the time of completing printing on a current printout page, as to whether there is fax data to be printed on the next printing medium; when there is fax data to be printed on the next printing medium, determining by using a sensor as to whether there is a printing medium to print out the fax data; and when there is no printing medium, displaying a message on the lower portion of the current printout page, indicating that there is more fax data to be printed, and storing the fax data in a memory. The fact that there is fax data waiting to be printed, can be indicated in the lower portion of the last page of the printouts such that the user is saved from inconvenient processes such as contacting the external source to check whether all the intended pages are safely received or not.

### CROSS-REFERENCE TO RELATED APPLICATIONS

This application claims the benefit of Korean Patent Application No. 2004-03049 filed Jan. 5, 2004, in the Korean Intellectual Property Office, the disclosure of which is incorporated herein by reference.

### BACKGROUND OF THE INVENTION

1. Field of the Invention

The present general inventive concept relates to a multi-function peripheral (MFP) device including a scanner and facsimile functions therein and a method thereof informing A user of a shortage of printing media, and more particularly, to an MFP and a method thereof, which informs A user of a shortage of printing media during facsimile data reception by printing out on the lower portion of the last available page of the printing media for the user's notice of the fact that there are received facsimile data yet to be printed.

2. Description of the Related Art

Generally, a multi-function peripheral, known as an MFP device, comprises various functions of existing office appliances such as a facsimile, scanner, printer and copier, integrated into a single terminal type, and used independently, or in association with a computer.

FIG. 1 is a block diagram of a conventional general MFP device. Referring to FIG. 1, the architecture and operation of the conventional MFP device will be briefly described.

The conventional MFP device 10 comprises a control part 11, a memory 12, an operating panel 13, a scanner 14, a print engine part 15, a sensor part 16, a modem 17, an NCU 18, and a PC interface part 19.

The control part 11 controls the overall operation of the MFP device 10 in accordance with predetermined program modes.

The memory 12, under the control of the control part 11, temporarily stores, or outputs data which include data transmitted from a Public Switched Telephone Network (PSTN), program data, protocol data, text data and audio data transmitted from the computer 20. The operating panel 13, or OPE, comprises a key matrix which contains various numeral keys and function keys to set functions on the menu. The OPE 13 provides the control part 11 with key data which are generated according to the key manipulation thereof. Additionally, there is a liquid crystal display (LCD) provided inside the OPE 13 to display status and information about the MFP device 10 according to the control of the control part 11.

In the data transfer mode or copy mode setting for the facsimile function or copying function, the scanner 14, under control of the control part 11, scans the received document, converts scanned data into suitable image data and transfers the image data to the control part 11. The print engine part 15 prints the data including the data from the scanner 14 and from the computer 20, according to the control of the control part 11.

The sensor part 16 senses the status of respective parts according to the operation of the MFP device 10, and provides the sensed information to the control part 11. The modem 17, under control of the control part 11, modulates digital signal from the control part 11 into analog signal and outputs the same. Also, the modem 17 demodulates the analog signal received from the PSTN via a network control unit (NCU) 18 into a digital signal, and transfers the same to the control part 11. According to the control of the control part 11, the NCU 18 forms a communication path to the PSTN and the modem 17 to interface signals from the PSTN and the modem 17. The NCU 18 comprises a speech circuit, a dialing circuit and a ring signal detect circuit, which are basic elements to realize functions of the telephone.

The PC interface part 19 interconnects the computer 20 and the MFP device 10 for inter-communication in a manner such that according to the control of the control part 11, data received through the PSTN or data read from the scanner 14 are transferred to the computer 20, or data from the computer 20 are transferred to the MFP device 10.

The facsimile part of the MFP device 10 as the one described above carries out data communication through the PSTN, and during data reception from the sending side, the transmitted data usually includes information to identify the sender, which in the present setting, is referred to as a transmission terminal identification (TTI) data. The TTI data can be displayed through an LCD for a predetermined time during the data reception, or outputted to the upper portion of the printout in a predetermined pattern, with reception time and number of received copies being stored in the memory as reception information.

The conventional system, however, had shortcomings which are mainly associated with the TTI data indicating function. That is, in consideration of limited memory capacity, the TTI data is usually indicated in the form of a page number. Accordingly, the user does not know how many copies of data he/she has received and whether the printout page is the last part of the received data or not. Furthermore, if the printing pages run out during the reception of the document data, the receiver machine stores un-printed data in the memory. However, if the un-printed data exceeds the storage capacity of the memory, the receiver automatically ends the communication.

When this happens, the user at the receiver side frequently and believes that all the intended data has been received rather than recognizing that there has been an error because if the user does not notice the warning on the LCD, the chances are high that the user simply overlooks the fact that there is more data yet to be printed. Furthermore, if the user does not supply new printing media, the data is continuously stored in the memory, sometimes causing data overflow and subsequent communication errors.

### SUMMARY OF THE INVENTION

Accordingly, the present invention has been made to solve the above-mentioned and/or other problems occurring in the related art, and an aspect of the present general inventive concept is to provide a multi-function peripheral (MFP) device and a method thereof, which, mainly during facsimile data reception and printing, indicates on the lower part of the last printout about the fact that there is fax data waiting to be printed, to thus improve user convenience and also enable the user to supply new printing media in a timely manner so as to avoid data overflow at a memory location.

Additional aspects and advantages of the present general inventive concept will be set forth in part in the description which follows and, in part, will be obvious from the description, or may be learned by practice of the general inventive concept.

The above and/or other aspects and features of the present general inventive concept can be achieved by providing a method of indicating that there is a shortage of printing media in a multi-functional peripheral device which receives predetermined data including fax data from an external source and prints the received data, the method including printing the received fax data on printing media, determining through predetermined fax protocol data which is received from the external source at a time of completing printing on a current page of the printing media, as to whether there is more fax data to be printed on a next page of the printing media, and when there is more fax data to be printed on the next page, receiving the fax data and determining, by using a sensor, as to whether there is the next page to print out the received fax data; and when there is no next page available, displaying a message on the lower portion of the current page, indicating that there is more fax data to be printed, and storing the received fax data in a memory.

The time of completing the printing on the current page corresponds to a time when a remote terminal identification (RTI) indicating information about the multi-functional peripheral device is printed.

When there is no fax data to be printed on the next page of the printing media, further comprising displaying the completion of fax data transmission on a lower portion of the current page of the printing media.

When there is the next page of the printing media available, further comprising printing the received fax data from the external source on the next page of the printing media.

The fax protocol data may include one of a multi-page signal (MPS) and an end of message (EOM).

The above and/or other aspects and features of the present general inventive concept may also be achieved by providing a multi-functional peripheral device to receive a predetermined data including fax data from an external source, including: a print engine part that prints the received fax data on a printing medium; a memory that receives and stores the fax data when there is more fax data transmitted from the external source; a sensor part that determines whether a printing medium is available to print the received fax data stored in the memory; and a control part that determines, if it is determined that there is no printing medium available to print the received fax data, whether there is fax data to be printed on the next page of the printing medium at the time of completing the printing on the current page, and if so, controlling such that message information is formed on a lower portion of the current page indicating that more fax data is waiting to be printed.

The determining whether there is fax data to be printed may be performed by using a fax protocol data received from the external source.

The time of completing the printing on the current page corresponds to the time when a remote terminal identification (RTI), indicating information about a receiver side, is printed.

The fax protocol data may include one of a multi-page signal (MPS) and an end of message (EOM).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional general multi-function peripheral (MFP) device; and

FIG. 2 is a flowchart explaining a method of informing the user of a shortage of printing media according to an embodiment of the present general inventive concept.

### DETAILED DESCRIPTION OF THE PREFERRED EMBODIMENTS

Certain embodiments of the present general inventive concept will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

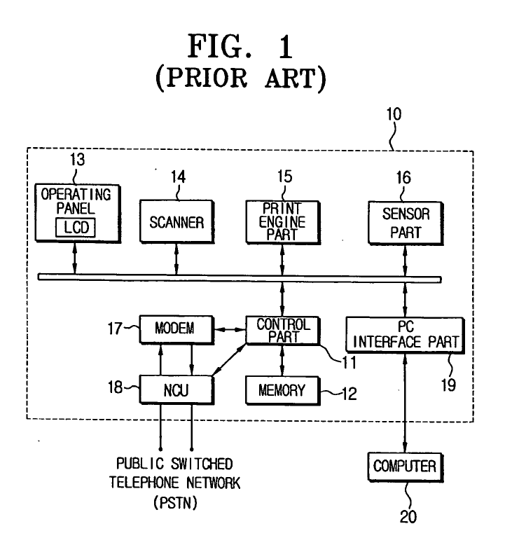

Referring to FIG. 1, when predetermined data, inclusive of facsimile data, is received from an external source, a print engine part 15 of a multi-function peripheral device (MFP) 10 prints the received data on printing media.

By using facsimile protocol data received from the external source, the control part 11 determines, at the time of completing the printing on a current page of the printing media, as to whether there is data to be printed on a next page. If so, the memory 12 can receive and store the facsimile data therein. A sensor part 16 determines whether there is a printing medium of the printing media to print the data that is stored in the memory 12.

When all of the printing media are determined by the sensor part 16 to have been used up, i.e., when there is no printing media left, the control part 11 can control the print engine 15 to print a notice on a lower end of the current printout page indicating that more data is waiting to be printed.

When there is no more fax data to be printed, the control part 11 controls the print engine 15 to print a notice on the lower end of the current page indicating that the transmission of fax data has been completed.

If there is data waiting and printing media is available, the control part 11 can control the print engine 15 to print the fax data on the following printing medium.

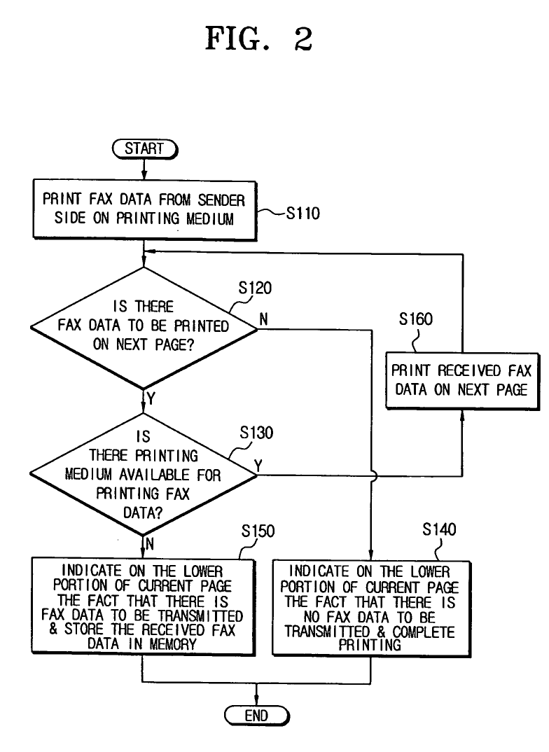

FIG. 2 is a flowchart explaining a method according to an embodiment of the present general inventive concept, which informs the user when there is a shortage of printing media.

Referring to FIGS. 1 and 2, when certain data including fax data is received from an external source, the print engine part 15 starts printing the received data on the printing media (operation S110). As the fax data is printed on a first page of the printing media, a transmission terminal identification is recorded on an upper portion of the current printout page showing information about the external source, while a remote terminal identification (RTI) is recorded on a lower portion of the current printout page showing information about the MFR device 10.

At a time of completing printing on the current page, i.e., when the printing of the RTI is about to be complete, the control part 11 reads the fax protocol data transmitted from the external source. Using the fax protocol data, the control part 11 determines whether there is more data to be transmitted from the external source to be printed on the following page (operation S120). The fax protocol data may include a multi-page signal (MPS) and end of message (EOM).

If no more fax data is transmitted from the external source, it is indicated in the lower portion of the current printout page that transmission from the external source is completed (operation S140).

If there is fax data transmitted from the external source to be printed on the following page of the printing media, the sensor part 16 determines whether there is a printing medium available to print the transmitted data thereon (operation S130). The sensor part 16 may include a paper sensor.

If there is more fax data to be printed, and printing media is available, the fax data is received from the external source and printed on the printing media (operation S160). The following operation is identical to operation S120, in which the existence of fax data to be printed on the following printing medium is determined by use of fax protocol information.

If there is no more printing media left and printing is thus prevented, the control part 11 controls printing information, for example, in the form of a message on the lower portion of the current printout page informing the user that more fax data is waiting to be printed, and afterwards, the data received from the external source is stored in the memory 12 (operation S150). For example, messages such as ‘THERE IS MORE DATA FOR PRINTING’ or ‘PLEASE FEED PAPER TO CONTINUE PRINTING’ can be indicated on the lower portion of the current printout page.

Based on the information printed on the lower current portion of the printout page in the form of messages, the user easily understands whether the received data is completely printed or not.

As described in a few exemplary embodiments of the present general inventive concept, the fact that there is fax data waiting to be printed, is indicated in the lower portion of the last available page of the print media such that the user is saved from inconvenient processes such as contacting the sender to check whether all the intended pages are safely received or not.

Additionally, because an adequate warning message is given to the user when there is a shortage of printing media, receiving of fax data to the extent exceeding the memory capacity can be prevented.

The foregoing embodiment and advantages are merely exemplary and are not to be construed as limiting the present general inventive concept. The present teachings can be readily applied to other types of apparatuses. Also, the description of the embodiments of the present general inventive concept is intended to be illustrative, and not to limit the scope of the claims, and many alternatives, modifications, and variations will be apparent to those skilled in the art.

1. A method of indicating that there is a shortage of printing media in a multi-functional peripheral device which receives predetermined data including fax data from an external source and prints the received data, the method comprising:
printing the received fax data on printing media;
determining through predetermined fax protocol data which is received from the external source and at a time of completing printing on a current page of the printing media, as to whether there is fax data to be printed on a next page of the printing media;
when there is fax data to be printed on the next page of the printing media, determining whether there is the next page of the printing media to print out the fax data; and
when there is no next page of the printing media, displaying a message on a lower portion of the current page, indicating that there is more fax data to be printed, and storing the fax data in a memory.

2. The method of claim 1, wherein a time of completing the printing of the received fax data on the current page corresponds to a time when a remote terminal identification (RTI) indicating information about the multi-functional peripheral device is printed.

3. The method of claim 1, when there is no fax data to be printed on the following page of the printing media, further comprising displaying the completion of fax data transmission on a lower portion of the current page of the printing media.

4. The method of claim 1, when there is the next page of the printing media, further comprising printing the received fax data on next page of the printing media.

5. The method of claim 1, wherein the fax protocol data comprises one of a multi-page signal (MPS) and an end of message (EOM).

6. The method of claim 1, wherein the determining whether there is a printing medium for printing out the fax data is performed by sensing the existence of a printing medium using a sensor.

7. A method of managing printing of data including facsimile data received by a multi-functional peripheral device (MFP) from an external source, the method comprising:
printing the received data on printing media until all of the data received has been printed, or until it is determined that a next page of the printing media does not exist;
displaying a message on a lower portion of the current page of the printing media if it is determined that a next page of the printing media does not exist; and
storing the received data remaining to be printed if in a memory if a next page of the printing media does not exist.

8. The method of claim 7, wherein the message displayed on the lower portion of the current page is a message indicating that there is more data to be printed.

9. The method of claim 7, wherein the message displayed on the lower portion of the current page is a message indicating that there is no more printing media to complete printing the data.

10. The method of claim 7, wherein a time of completing the printing of received data on the current page corresponds to a time when a remote terminal identification (RTI) indicating information about the MFP is printed.

11. The method of claim 7, further comprising displaying the completion of received data transmission on a lower portion of the current printout page of the printing media when there is no data to be printed on a following page of the printing media.

12. A multi-functional peripheral (MFP) device that receives predetermined data including fax data from an external source, the multi-functional peripheral device comprising:
an image forming part that prints the received fax data on printing media;
a memory that stores and receives the fax data when there is more fax data transmitted from the external source;
a sensor part that determines whether a printing medium is available to print the received fax data stored in the memory; and
a control part that determines, if it is determined that no printing medium is available to print the received fax data, whether there is fax data to be printed on the next page of the printing media at a time of completing the printing on a current page, and if so, controlling the printing of information on a lower portion of the current page indicating that more fax data is waiting to be printed.

13. The multi-functional peripheral (MFP) device of claim 12, wherein the determining whether there is fax data to be printed on the next page of the printing media is performed by using fax protocol data received from the external source,

14. The multi-functional peripheral of claim 13, wherein the time of completing the printing on the current page corresponds to the time when a remote terminal identification (RTI), indicating information about a receiver side, is printed.

15. The multi-functional peripheral of claim 13, wherein the fax protocol data comprises one of a multi-page signal (MPS) and an end of message (EOM).

16. A multi-functional peripheral (MFP) device that receives data including facsimile data from an external source, the MFP comprising:
an printing unit that prints the received data on printing media;
a sensor that determines whether printing media is available to print the received data;
a controller that determines, if it is determined that no printing media remains to print the received data thereon, whether there is data remaining to be printed on the printing media at a time of completing the printing of data on the current page of the printing media, and if so, controlling the printing unit to print a message on a lower portion of the current page of printing media indicating that more data is waiting to be printed; and
a memory that receives and stores the received data remaining to be printed when it is determined that there is no more printing media.

17. The multi-functional peripheral (MFP) device of claim 16, wherein the controller determines whether there is data remaining to be printed on the printing media by using protocol data from the received data.

18. The multi-functional peripheral of claim 16, wherein a time of completing the printing on a current page of the printing media corresponds to a time when a remote terminal identification (RTI) indicating information about a receiver side is printed.

19. The multi-functional peripheral of claim 17, wherein the protocol data comprises one of a multi-page signal (MPS) and an end of message (EOM).

20. A multi-functional peripheral (MFP) device that receives data including facsimile data from an external source, the MFP comprising:
an printing unit that prints the received data on printing media;
a controller that determines whether printing media exists to print the received data thereon, and if there is no printing media remaining to print the received data, then determines whether there is data remaining to be printed on the printing media at a time of completing the printing of data on the current page of the printing media, and if so, controlling the printing unit to print a message on a lower portion of the current page of printing media indicating that more data is waiting to be printed; and
a memory that receives and stores the received data remaining to be printed when it is determined that there is no more printing media.

21. The multi-functional peripheral (MFP) device of claim 20, wherein the controller determines whether there is data remaining to be printed on the printing media by using protocol data from the received data.
